(19) United States
(12) Patent Application Publication
(10) Pub. No.: US 2025/0115129 A1
(43) Pub. Date: Apr. 10, 2025

(54) VEHICLE DISPLAY CONTROL DEVICE

(71) Applicant: TOYOTA JIDOSHA KABUSHIKI KAISHA, Toyota-shi Aichi-ken (JP)

(72) Inventors: Miki TSUJINO, Nagakute-shi Aichi-ken (JP); Matthew COREY HALL, Meguro-ku Tokyo-to (JP); Lorcan O'SHANAHAN, Minato-ku Tokyo-to (JP); Piotr KLAROWSKI, Setagaya-ku Tokyo-to (JP); MW van der WALT, Meguro-ku Tokyo-to (JP); Stuart PARSON, Shibuya-ku Tokyo-to (JP); Stephanie PARK, Minato-ku Tokyo-to (JP)

(73) Assignee: TOYOTA JIDOSHA KABUSHIKI KAISHA, Toyota-shi Aichi-ken (JP)

(21) Appl. No.: 18/904,448

(22) Filed: Oct. 2, 2024

(30) Foreign Application Priority Data
Oct. 4, 2023 (JP) 2023-173163

(51) Int. Cl. B60K 35/28; B60K 35/21; G06T 3/40; G06T 15/20

(52) U.S. Cl. CPC B60K 35/28; B60K 35/21; G06T 3/40; G06T 15/20; B60K 2360/16

(57) ABSTRACT

A vehicle display control device including a processor and a display section that is provided at a vehicle capable of executing driving assistance control, and that is configured to display a vehicle image representing the vehicle, wherein the processor is configured to determine whether or not a switching condition for switching the driving assistance control from a non-actuated state to an actuated state has been satisfied, and, when it has been determined that the switching condition has been satisfied, control the display section so as to display the vehicle image while changing a display mode of the vehicle image.

### CROSS-REFERENCE TO RELATED APPLICATION

This application is based on and claims priority under 35 USC 119 from Japanese Patent Application No. 2023-173163 filed on Oct. 4, 2023, the disclosure of which is incorporated by reference herein.

### BACKGROUND

### Technical Field

The present disclosure relates to a vehicle display control device.

### Related Art

U.S. Patent Application Publication No. 2017/0136878 discloses a vehicle display control device that displays an image representing a vehicle (own vehicle) and an image representing a peripheral state of the vehicle at a display section, while changing a display mode of these images.

U.S. Patent Application Publication No. 2017/0136878 has room for improvement with respect to causing an occupant of the vehicle to recognize that driving assistance control has actually started to be actuated.

In consideration of the aforementioned circumstances, an object of the present disclosure is to obtain a vehicle display control device that enables an occupant viewing the display section to easily recognize that driving assistance control has been switched from a non-actuated state to an actuated state.

### SUMMARY

A vehicle display control device according to a first aspect includes: a processor; and a display section that is provided at a vehicle capable of executing driving assistance control, and that is configured to display a vehicle image representing the vehicle, the processor being configured to: determine whether or not a switching condition for switching the driving assistance control from a non-actuated state to an actuated state has been satisfied, and, when it has been determined that the switching condition has been satisfied, control the display section so as to display the vehicle image while changing a display mode of the vehicle image.

As explained above, the vehicle display control device according to the present disclosure has an effect of enabling an occupant viewing the display section to easily recognize that the driving assistance control has been switched from the non-actuated state to the actuated state.

### BRIEF DESCRIPTION OF THE DRAWINGS

An exemplary embodiment of the present disclosure will be described in detail based on the following figures, wherein:

FIG. 1 is a schematic plan view of a vehicle including a vehicle display control device according to an exemplary embodiment.

FIG. 2 is a diagram illustrating a vehicle interior of the vehicle illustrated in FIG. 1.

FIG. 3 is a functional block diagram of an ECU illustrated in FIG. 2.

FIG. 4 is a schematic side view illustrating a positional relationship between the vehicle and a virtual viewpoint.

FIG. 5 is a diagram illustrating a display section displaying a vehicle image representing the vehicle traveling on a road and a road image representing the road, when blind spot monitoring control has been switched to an actuated state.

FIG. 6 is a diagram illustrating the display section when the blind spot monitoring control is in the actuated state.

FIG. 7 is a diagram illustrating the display section when the blind spot monitoring control is in the actuated state and an approaching vehicle notification image is displayed.

FIG. 8 is a diagram illustrating the display section displaying the vehicle image representing the vehicle stopped on the road and the road image, when safe exit assistance control has been switched to an actuated state.

FIG. 9 is a diagram illustrating the display section when the safe exit assistance control is in the actuated state.

FIG. 10 is a diagram illustrating the display section when the safe exit assistance control is in the actuated state and an approaching target object notification image is displayed.

FIG. 11 is a diagram illustrating the display section displaying the vehicle image representing the vehicle positioned in a parking lot, when parking notification control has been switched to an actuated state.

FIG. 12 is a diagram illustrating the display section when the parking notification control is in the actuated state.

FIG. 13 is a diagram illustrating the display section when the parking notification control is in the actuated state and a peripheral target object notification image is displayed.

FIG. 14 is a flowchart illustrating processing executed by a CPU of the ECU.

### DETAILED DESCRIPTION

An exemplary embodiment of a vehicle display control device according to the present disclosure will be explained below, with reference to the appended drawings.

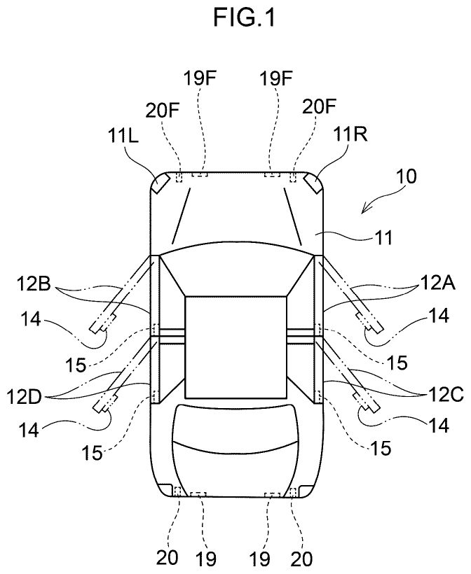

A vehicle 10 illustrated in FIG. 1 includes a vehicle body 11, and four doors 12A, 12B, 12C, and 12D that open and close four opening portions formed at side faces of the vehicle body 11. Each of the doors 12A, 12B, 12C, and 12D is capable of relative rotation with respect to the vehicle body 11 between a closed position (a position indicated by solid lines in FIG. 1) at which a corresponding opening portion is closed, and an open position (a position indicated by virtual lines in FIG. 1) at which the opening portion is open. Moreover, a door lock device including an electric actuator is provided at each of the doors 12A, 12B, 12C, and 12D. Each door lock device is switchable by a driving force of the electric actuator between a latched state (a locked state) in which the door 12A, 12B, 12C, or 12D positioned at the closed position is retained at the closed position, and an unlatched state (an unlocked state) in which the door 12A, 12B, 12C, or 12D is allowed to rotate between the closed position and the open position.

Further, an inside handle 14 is provided at an inner face of each of the doors 12A, 12B, 12C, and 12D. When the inside handle 14 is rotationally operated in a state in which a locking knob (not illustrated in the drawings) provided at the door 12A, 12B, 12C, or 12D is at an unlocked position, the door 12A, 12B, 12C, or 12D, which was in the latched state, is put in the unlatched state.

Furthermore, four opening and closing determination switches 15 that determine whether each of the doors 12A, 12B, 12C, and 12D is in the latched state or the unlatched state are provided at the vehicle body 11. Each opening and closing determination switch 15 outputs an unlatching signal when the corresponding door 12A, 12B, 12C, or 12D has changed from the latched state to the unlatched state.

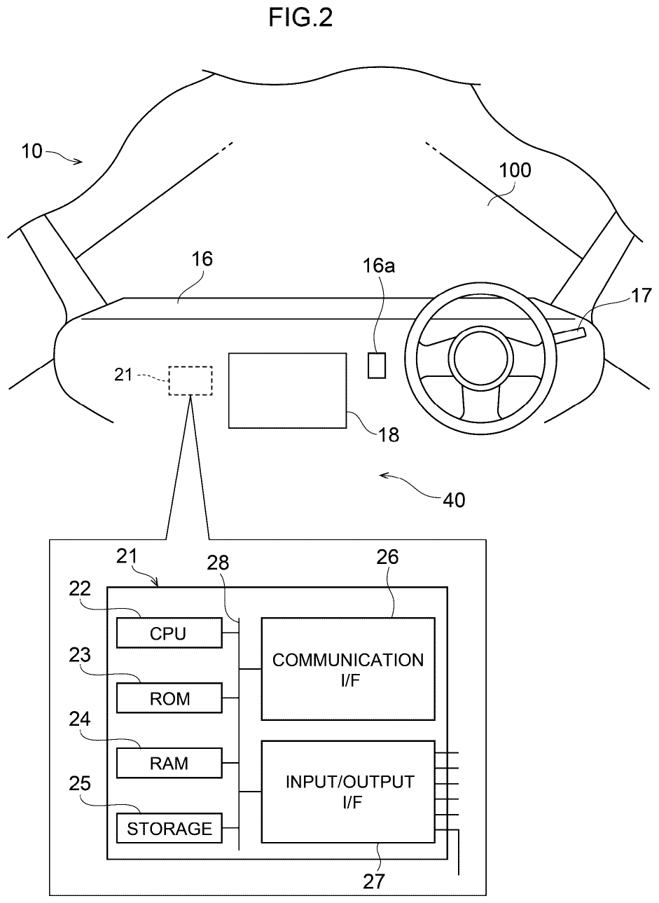

As illustrated in FIG. 2, a turn signal lever 17 is rotatably supported at a steering column provided at an instrument panel 16 of the vehicle 10. When the turn signal lever 17 is rotated from an initial position to a first illuminating position thereabove, a turn signal 11L (refer to FIG. 1) provided at a left side of a front portion of the vehicle body 11 is illuminated, and when the turn signal lever 17 is rotated from the initial position to a second illuminating position therebelow, a turn signal 11R (refer to FIG. 1) provided at a right side of the front portion of the vehicle body 11 is illuminated.

Further, as illustrated in FIG. 2, a display section 18 is provided at the instrument panel 16. As described later, the display section 18 is capable of displaying various images.

Furthermore, as illustrated in FIG. 1, plural radar sensors 19 and plural clearance sonars 20 are provided at a rear portion of the vehicle 10. The radar sensors 19 determine a position of a target object and a relative speed of the target object with respect to the vehicle 10 using radio waves in a millimeter wave band (hereafter, “millimeter waves”). Specifically, the radar sensors 19 emit millimeter waves obliquely rearward of the vehicle 10, and receive millimeter waves (reflected waves) that have been reflected by the target object, which is a three-dimensional object that is present within an emission range of the millimeter waves. The radar sensors 19 transmit transmission and reception data of the millimeter waves to an electronic control unit (ECU) 21. The clearance sonars 20 are, for example, ultrasonic wave sensors, and determine a distance from the clearance sonars 20 (the vehicle 10) to the target object based on a time until ultrasonic waves transmitted by the clearance sonars 20 are reflected off the target object (the three-dimensional object) and received. A determination distance of the clearance sonars 20 is, for example, about several cm to 100 cm.

As illustrated in FIG. 2, the ECU 21 is configured to include a central processing unit (CPU) (processor) 22, a read only memory (ROM) (non-transitory recording medium) 23, a random access memory (RAM) 24, a storage (non-transitory recording medium) 25, a communication interface (I/F) 26, and an input/output I/F 27. The CPU 22, the ROM 23, the RAM 24, the storage 25, the communication I/F 26, and the input/output I/F 27 are connected so as to be capable of communicating with each other via a bus 28. The ECU 21 is capable of acquiring information related to a date and time from a timer (not illustrated in the drawings).

The CPU 22 is a central arithmetic processing unit, and the CPU 22 executes various types of programs and controls various sections. Namely, the CPU 22 reads out programs from the ROM 23 or the storage 25, and executes the programs using the RAM 24 as a workspace. The CPU 22 carries out control of various configurations and various types of arithmetic processing (information processing) according to programs recorded in the ROM 23 or the storage 25.

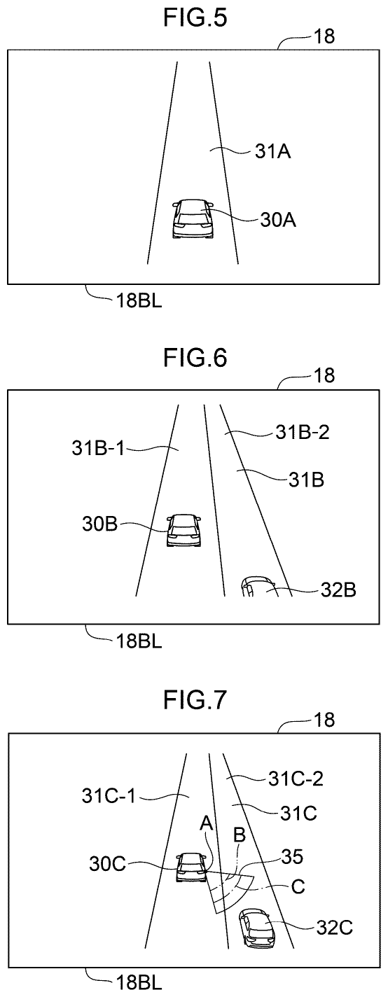

The ROM 23 stores various types of programs and various types of data. These data include, for example, three dimensions (3D) modeling data forming the basis for image data representing vehicle images 30A, 30B, 30C, 30D, and 30E, road images 31A, 31B, 31C, 31D, and 31E, approaching vehicle images 32B and 32C, and parked vehicle images 33D and 33E illustrated in FIGS. 5 to 13. The 3D modeling data includes, for example, 3D modeling data of the vehicle 10, 3D modeling data of an approaching vehicle (a following vehicle), which will be described later, 3D modeling data of a parked vehicle, which will be described later, and 3D modeling data of a road 100, which will be described later. The respective 3D modeling data is arranged in a 3D virtual space. When a position of a virtual viewpoint, which will be described later, changes, a shape of a target object represented by each of the 3D modeling data, when viewed from the virtual viewpoint, changes.

The vehicle images 30A, 30B, 30C, 30D, and 30E, and the road images 31A, 31B, 31C, 31D, and 31E, are displayed at the display section 18, for example, when the vehicle 10 is traveling along the road 100 illustrated in FIG. 2.

The vehicle image 30A illustrated in FIG. 5 is an image based on 3D modeling data when the 3D modeling data of the vehicle 10 arranged in a 3D virtual space is viewed from a virtual viewpoint PA in FIG. 4, and is generated by a display control section 222, which will be described later. The road image 31A illustrated in FIG. 5 is an image based on 3D modeling data when the 3D modeling data of the road 100 arranged in the 3D virtual space is viewed from the virtual view point PA, and is generated by the display control section 222, when the display control section 222 has recognized the road 100 based on detection results of plural radar sensors 19F and plural clearance sonars 20F that are provided at the front portion of the vehicle 10.

The vehicle image 30B and the road image 31B illustrated in FIG. 6 are images that are generated by the display control section 222 in the same manner as the vehicle image 30A and the road image 31A, and are images based on 3D modeling data when the 3D modeling data of the vehicle 10 and the 3D modeling data of the road 100 are viewed from a virtual viewpoint PB in FIG. 4. It should be noted that, in a case in which a number of lanes of the road 100 is two, the road image 31B includes a lane image 31B-1 and a lane image 31B-2, as illustrated in FIG. 6.

The vehicle image 30C and the road image 31C illustrated in FIG. 7 are images generated by the display control section 222 in the same manner as the vehicle image 30A and the road image 31A, and are images based on 3D modeling data when the 3D modeling data of the vehicle 10 and the 3D modeling data of the road 100 are viewed from a virtual viewpoint PC in FIG. 4. The road image 31C in FIG. 7 includes a lane image 31C-1 and a lane image 31C-2. The approaching vehicle image 32B in FIG. 6 is an image based on 3D modeling data when 3D modeling data of an approaching vehicle arranged in the 3D virtual space is viewed from the virtual viewpoint PB, and is generated by the display control section 222, when the display control section 222 has recognized an approaching vehicle (a following vehicle), which is traveling in an adjacent lane that is adjacent to a lane in which the vehicle 10 is traveling and is positioned further rearward than the vehicle 10, based on detection results of the radar sensors 19 and the clearance sonars 20. The approaching vehicle image 32C in FIG. 7 is an image when the approaching vehicle is viewed from the virtual viewpoint PC.

As illustrated in FIG. 4, the virtual viewpoint PA, the virtual viewpoint PB, and the virtual viewpoint PC are positioned on a single virtual straight line L1. Moreover, a field of view angle θA illustrated in FIG. 4 is a field of view angle when the vehicle 10 is viewed from the virtual viewpoint PA. A field of view angle θB is a field of view angle when the vehicle 10 is viewed from the virtual viewpoint PB, and a field of view angle θC is a field of view angle when the vehicle 10 is viewed from the virtual viewpoint PC. A distance from the virtual viewpoint PB to the vehicle 10 is longer than a distance from the virtual viewpoint PA to the vehicle 10, and a distance from the virtual viewpoint PC to the vehicle 10 is longer than the distance from the virtual viewpoint PB to the vehicle 10. Furthermore, the field of view angles θA, θB, and θC are the same. Consequently, as is apparent from FIGS. 5 to 7, the vehicle image 30B in FIG. 6 is smaller than the vehicle image 30A in FIG. 5, and the vehicle image 30C in FIG. 7 is smaller than the vehicle image 30B. Similarly, the approaching vehicle image 32C in FIG. 7 is smaller than the approaching vehicle image 32B in FIG. 6.

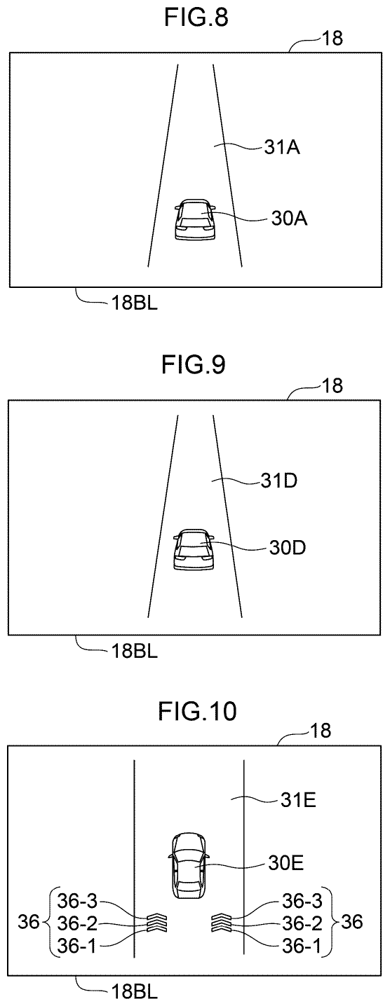

The vehicle image 30A and the road image 31A illustrated in FIG. 8 are images generated in the same manner as the vehicle image 30A and the road image 31A illustrated in FIG. 5, and represent the vehicle 10 and the road 100 when the vehicle 10 stopped on the road 100 is viewed from the virtual viewpoint PA illustrated in FIG. 4. The vehicle image 30D and the road image 31D illustrated in FIG. 9 are images generated by the display control section 222 in the same manner as the vehicle image 30A and the road image 31A, and are images based on 3D modeling data when the 3D modeling data of the vehicle 10 and the 3D modeling data of the road 100 are viewed from a virtual viewpoint PD in FIG. 4. The vehicle image 30E and the road image 31E illustrated in FIG. 10 are images generated by the display control section 222 in the same manner as the vehicle image 30A and the road image 31A, and are images based on 3D modeling data when the 3D modeling data of the vehicle 10 and the 3D modeling data of the road 100 are viewed from a virtual viewpoint PE in FIG. 4. As illustrated in FIG. 4, the virtual viewpoints PA, PD, and PE are positioned on a curve CL substantially having an arc shape. That is to say, the distance from the virtual viewpoint PA to the vehicle 10, a distance from the virtual viewpoint PD to the vehicle 10, and a distance from the virtual viewpoint PE to the vehicle 10 are substantially the same. As illustrated in FIG. 4, the virtual viewpoint PD is positioned further frontward and upward than the virtual viewpoint PA, and the virtual viewpoint PE is positioned further frontward than the virtual viewpoint PD. The virtual viewpoint PE is positioned directly above a center portion, in a front-rear direction, of the vehicle 10. Moreover, a field of view angle θD when the vehicle 10 is viewed from the virtual viewpoint PD, and a field of view angle θE when the vehicle 10 is viewed from the virtual viewpoint PE are the same as the field of view angles θA, θB, and θC. Consequently, as is apparent from FIGS. 8 to 10, a shape of the vehicle image 30A in FIG. 8, a shape of the vehicle image 30D in FIG. 9, and a shape of the vehicle image 30E in FIG. 10 are different from each other. Similarly, a shape of the road image 31A in FIG. 8, a shape of the road image 31D in FIG. 9, and a shape of the road image 31E in FIG. 10 are different from each other.

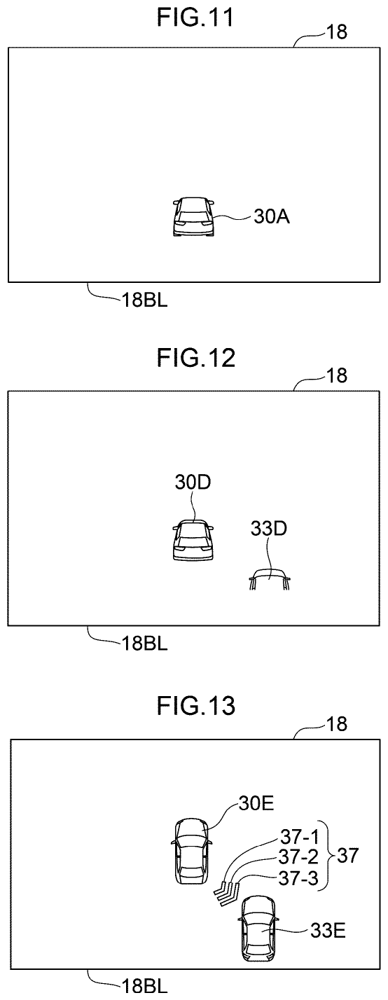

The vehicle image 30A illustrated in FIG. 11 is an image generated in the same manner as the vehicle image 30A in FIG. 5, and represents the vehicle 10 when the vehicle 10 traveling at a low speed in a parking lot is viewed from the virtual viewpoint PA. The vehicle image 30D illustrated in FIG. 12 is an image generated in the same manner as the vehicle image 30A in FIG. 5, and represents the vehicle 10 when the vehicle 10 traveling at a low speed in a parking lot is viewed from the virtual viewpoint PD. The vehicle image 30E illustrated in FIG. 13 is an image generated in the same manner as the vehicle image 30A in FIG. 5, and represents the vehicle 10 when the vehicle 10 traveling at a low speed in a parking lot is viewed from the virtual viewpoint PE. The parked vehicle image 33D illustrated in FIG. 12 is an image based on 3D modeling data when 3D modeling data of a parked vehicle arranged in the 3D virtual space is viewed from the virtual viewpoint PD, and is generated by the display control section 222 when the display control section 222 has recognized a parked vehicle, positioned obliquely rearward of the vehicle 10 and parked in the parking lot, based on detection results of the radar sensors 19 and the clearance sonars 20. The parked vehicle image 33E illustrated in FIG. 13 is an image when the parked vehicle is viewed from the virtual viewpoint PE.

Moreover, an approaching vehicle notification image (notification image) 35 illustrated in FIG. 7, an approaching target object notification image (notification image) 36 illustrated in FIG. 10, and a peripheral target object notification image (notification image) 37 illustrated in FIG. 13 are stored in the ROM 23. The approaching vehicle notification image 35, the approaching target object notification image 36, and the peripheral target object notification image 37 will be described later. In the following explanation, the vehicle images 30A, 30B, 30C, 30D, and 30E, the road images 31A, 31B, 31C, 31D, and 31E, the approaching vehicle images 32B and 32C, the parked vehicle images 33D and 33E, the approaching vehicle notification image 35, the approaching target object notification image 36, and the peripheral target object notification image 37 are sometimes referred to as “driving assistance-related images”.

The RAM 24 temporarily stores programs or data as a workspace. The storage 25 is configured by a storage device such as a hard disk drive (HDD), a solid state drive (SSD) or the like, and stores various types of programs and various types of data. The communication I/F 26 is an interface that is capable of communicating with devices that are positioned at an exterior of the vehicle 10. For example, the communication I/F 26 is capable of wirelessly communicating with an external server (not illustrated in the drawings). A communication standard such as Controller Area Network (CAN), Bluetooth (registered trademark), Wi-Fi (registered trademark) or the like is used for the communication I/F 26. Moreover, the communication I/F 26 is capable of communicating with an ECU other than the ECU 21 provided at the vehicle 10, via an external bus.

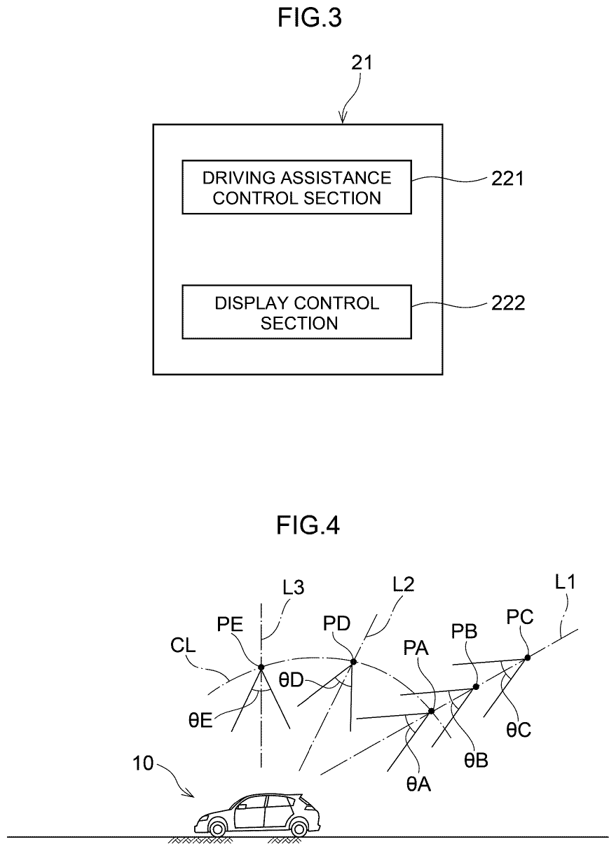

As illustrated in FIG. 3, the ECU 21 (processor) has, as functional configurations, a driving assistance control section (assistance control determination section) 221 and the display control section 222. The driving assistance control section 221 and the display control section 222 are realized due to the CPU 22 of the ECU 21 reading out and executing programs stored in the ROM 23.

When a driving assistance operation device 16a (refer to FIG. 2) provided at the instrument panel 16 is in an ON state, the driving assistance control section 221 causes the vehicle 10 to execute driving assistance control at an arbitrary driving level specified by the Society of Automotive Engineers (SAE), using a sensor group and an actuator group (not illustrated in the drawings) provided at the vehicle 10. Moreover, when the driving assistance operation device 16a is in the ON state, an occupant of the vehicle 10 can select a driving level and driving assistance control that is to be executed, by operating the driving assistance operation device 16a. The driving assistance control of the present exemplary embodiment includes, for example, blind spot monitoring control (hereinafter, BSM control), safe exit assistance control (hereafter, SEA control), and parking notification control. The sensor group provided at the vehicle 10 includes the radar sensors 19 and 19F and the clearance sonars 20 and 20F. The actuator group provided at the vehicle 10 includes, for example, an electric motor serving as a drive source.

In a case in which the driving assistance operation device 16a is in the ON state, the driving assistance control section 221 determines that a first switching condition (switching condition) for switching the BSM control from a non-actuated state to an actuated state has been satisfied when the radar sensors 19 detect that a distance between a vehicle (hereinafter, an approaching vehicle), which is traveling in an adjacent lane that is adjacent to a lane in which the vehicle 10 is traveling and is positioned further rearward than the vehicle 10, and the vehicle 10 is equal to or less than a first predetermined distance, and the turn signal lever 17 has been operated in a direction representing a position of the adjacent lane. In other words, in a case in which the distance between the vehicle 10 and the approaching vehicle is greater than the first predetermined distance, or in a case in which the turn signal lever 17 has not been operated in the direction representing the position of the adjacent lane, the driving assistance control section 221 determines that the first switching condition is not satisfied, and the BSM control is put in the non-actuated state. When the BSM control is put in the actuated state, a lamp (not illustrated in the drawings) provided at a door mirror of the vehicle 10 is put in an illuminated state. It should be noted that there is a time difference between a first time when the driving assistance control section 221 determines that the first switching condition has been satisfied, and a second time when the BSM control is actually switched from the non-actuated state to the actuated state.

In a case in which the driving assistance operation device 16a is in the ON state, the driving assistance control section 221 determines that a second switching condition (switching condition) for switching the SEA control from a non-actuated state to an actuated state has been satisfied, when a vehicle speed of the vehicle 10 is equal to or less than a first predetermined speed, the radar sensors 19 detect that a target object (hereafter, an approaching target object) positioned further rearward than the vehicle 10 is approaching the vehicle 10, and any of the opening and closing determination switches 15 is outputting an unlatching signal. In other words, in a case in which the vehicle speed of the vehicle 10 is higher than the first predetermined speed, in a case in which the radar sensors 19 have not detected that an approaching target object is approaching the vehicle 10, or in a case in which none of the opening and closing determination switches 15 is outputting an unlatching signal, the driving assistance control section 221 determines that the second switching condition is not satisfied, and the SEA control is put in the non-actuated state. When the SEA control is put in the actuated state, a speaker (not illustrated in the drawings) of the vehicle 10 generates a first notification sound. It should be noted that there is a time difference between a first time when the driving assistance control section 221 determines that the second switching condition has been satisfied, and a second time when the SEA control is actually switched from the non-actuated state to the actuated state.

In a case in which the driving assistance operation device 16a is in the ON state, the driving assistance control section 221 determines that a third switching condition (switching condition) for switching the parking notification control from a non-actuated state to a actuated state has been satisfied, when the vehicle speed of the vehicle 10 is faster than 0 km/h, the vehicle 10 is traveling at a vehicle speed that is slower than a second predetermined speed, and the clearance sonars 20 detect that a distance between the vehicle 10 and a target object (hereafter, a peripheral target object) positioned in a vicinity of the vehicle 10 has become equal to or less than a second predetermined distance. In other words, in a case in which the vehicle 10 is stopped, in a case in which the vehicle speed of the vehicle 10 is equal to or greater than the second predetermined speed, or in a case in which the clearance sonars 20 have not detected that a distance between the vehicle 10 and a peripheral target object is equal to or less than the second predetermined distance, the driving assistance control section 221 determines that the third switching condition is not satisfied, and the parking notification control is put in the non-actuated state. When the parking notification control is put in the actuated state, the speaker generates a second notification sound. It should be noted that there is a time difference between a first time when the driving assistance control section 221 determines that the third switching condition has been satisfied, and a second time when the parking notification control is actually switched from the non-actuated state to the actuated state.

As described above, the display control section 222 generates images based on 3D modeling data. Further, the display control section 222 causes the various images to be displayed at the display section 18. For example, in a case in which a navigation system installed at the vehicle 10 is in operation, the display control section 222 causes a map image (not illustrated in the drawings) to be displayed at the display section 18. Moreover, the display control section 222 is capable of causing an image representing the vehicle speed of the vehicle 10 to be displayed at the display section 18.

Furthermore, the display control section 222 switches the types of images to be displayed at the display section 18, based on whether or not the switching conditions (the first switching condition, the second switching condition, and the third switching condition) have been satisfied.

When the driving assistance control section 221 determines that the driving assistance control is in the non-actuated state, the display control section 222 sets the display section 18 to a normal mode. In other words, when the driving assistance control section 221 determines that the switching conditions are not satisfied, the display control section 222 sets the display section 18 to the normal mode. In a case in which setting to the normal mode has been carried out, the display control section 222 can, for example, cause the map image to be displayed at the display section 18, or cause the image representing the vehicle speed of the vehicle 10 to be displayed at the display section 18.

When the driving assistance control section 221 determines that a switching condition has been satisfied, the display control section 222 sets the display section 18 to a driving assistance mode. In a case in which setting to the driving assistance mode has been carried out, the display control section 222 causes the vehicle images 30A, 30B, 30C, 30D, and 30E to be displayed at the display section 18, as illustrated in FIGS. 5 to 13. As described above, there is a time difference between the first time and the second time. Consequently, the display control section 222 is capable of switching the display section 18 from the normal mode to the driving assistance mode after the second time, switching the display section 18 from the normal mode to the driving assistance mode prior to the second time, and switching the display section 18 from the normal mode to the driving assistance mode at the same time as the second time.

For example, when it is determined that the first switching condition related to BSM control has been satisfied in a state in which the map image is being displayed at the display section 18 in the normal mode, the display control section 222 switches the display section 18 to the driving assistance mode. That is to say, the display control section 222 clears the map image from the display section 18, and instead switches the display section 18 to the state illustrated in FIG. 5. The display control section 222 further switches the display section 18 to the state in FIG. 6, and further switches the display section 18 to the state in FIG. 7. It should be noted that, in actuality, the display section 18 switches continuously from the state in FIG. 5 to the state in FIG. 6, while passing through states in which a large number of vehicle images representing the vehicle 10, a large number of road images representing the road 100, and approaching vehicle images representing an approaching vehicle, when viewed from a large number of virtual viewpoints positioned on the virtual straight line L1, are displayed. Further, the display section 18 continuously switches from the state in FIG. 6 to the state in FIG. 7, while passing through states in which various vehicle images, road images, and approaching vehicle images are displayed. Consequently, the vehicle images 30A, 30B, and 30C displayed at the display section 18 gradually and continuously become smaller accompanying passage of time. Furthermore, display positions of the vehicle images 30A, 30B, and 30C on the display section 18 gradually move frontward.

Moreover, when the display section 18 is put in the state in FIG. 7, the display control section 222 causes the approaching vehicle notification image 35 to be displayed at the display section 18. The approaching vehicle notification image 35 is a sector-shaped image positioned between the vehicle image 30C and the approaching vehicle image 32C. Further, the approaching vehicle notification image 35 is gradually and continuously enlarged from the vehicle image 30C toward an approaching vehicle image 32C side. That is to say, the approaching vehicle notification image 35 starts to spread from a point A, and spreads to an area B indicated by a two-dot chain line. The approaching vehicle notification image 35 further spreads to an area C indicated by a one-dot chain line, and thereafter becomes a sector shape indicated by solid lines.

When the radar sensors 19 no longer detect that the distance between the vehicle 10 and the approaching vehicle is equal to or less than the first predetermined distance, it is determined that the first switching condition is not satisfied, and the BSM control is switched to the non-actuated state. Consequently, the display control section 222 switches the display section 18 to the normal mode.

Further, when it is determined that the second switching condition related to SEA control has been satisfied in a state in which the map image is being displayed at the display section 18 in the normal mode, the display control section 222 switches the display section 18 to the driving assistance mode. That is to say, the display control section 222 clears the map image from the display section 18, and instead switches the display section 18 to the state illustrated in FIG. 8. The display control section 222 further switches the display section 18 to the state in FIG. 9, and further switches the display section 18 to the state in FIG. 10. In a case in which the SEA control is in the actuated state, the display section 18 continuously switches from the state in FIG. 8 to the state in FIG. 10, while passing through states in which various vehicle images and road images are displayed. Consequently, accompanying passage of time, shapes of the vehicle images 30A, 30D, and 30E displayed at the display section 18 continuously change. Furthermore, display positions of the vehicle images 30A, 30D, and 30E on the display section 18 gradually move frontward.

Further, when the display section 18 is put in the state in FIG. 10, the display control section 222 causes the approaching target object notification image 36 to be displayed at the display section 18. In a case in which the radar sensors 19 detect that an approaching target object positioned in a region at a left side and rearward of the vehicle 10 is approaching the vehicle 10, for example, the approaching target object notification image 36 is displayed in a region at a left side of the road image 31E and further rearward than the vehicle image 30E. On the other hand, in a case in which the radar sensors 19 detect that an approaching target object positioned in a region at a right side and rearward of the vehicle 10 is approaching the vehicle 10, the approaching target object notification image 36 is displayed in a region at a right side of the road image 31E and further rearward than the vehicle image 30E. The approaching target object notification image 36 includes a first image 36-1, a second image 36-2, and a third image 36-3. Furthermore, the display control section 222 initially causes only the first image 36-1 to be displayed at the display section 18, then causes the first image 36-1 and the second image 36-2 to be displayed at the display section 18, and finally causes the first image 36-1, the second image 36-2, and the third image 36-3 to be displayed at the display section 18. Consequently, the approaching target object notification image 36 is continuously enlarged from the rear toward the front.

When the radar sensors 19 no longer detect that the approaching target object is approaching the vehicle 10, it is determined that the second switching condition is not satisfied, and the SEA control is switched to the non-actuated state. Consequently, the display control section 222 switches the display section 18 to the normal mode.

Further, when it is determined that the third switching condition related to the parking notification control has been satisfied in a state in which the map image is being displayed at the display section 18 in the normal mode, the display control section 222 switches the display section 18 to the driving assistance mode. That is to say, the display control section 222 clears the map image from the display section 18, and instead switches the display section 18 to the state illustrated in FIG. 11. The display control section 222 further switches the display section 18 to the state in FIG. 12, and further switches the display section 18 to the state in FIG. 13. In a case in which the parking notification control is in the actuated state, the display section 18 continuously switches from the state in FIG. 11 to the state in FIG. 12, while passing through states in which various vehicle images are displayed. Further, the display section 18 continuously switches from the state in FIG. 12 to the state in FIG. 13 while passing through states in which various vehicle images and parked vehicle images are displayed. Furthermore, display positions of the vehicle images 30A, 30D, and 30E on the display section 18 gradually move frontward.

Moreover, when the display section 18 is put in the state in FIG. 13, the display control section 222 causes the peripheral target object notification image 37 to be displayed at the display section 18. In a case in which the clearance sonars 20 detect that a parked vehicle (peripheral target object) is positioned in a region at a right side and rearward of the vehicle 10, for example, the peripheral target object notification image 37 is displayed in a region between the vehicle image 30E and the parked vehicle image 33E. The peripheral target object notification image 37 includes a first image 37-1, a second image 37-2, and a third image 37-3. Furthermore, the display control section 222 initially causes only the first image 37-1 to be displayed at the display section 18, then causes the first image 37-1 and the second image 37-2 to be displayed at the display section 18, and finally causes the first image 37-1, the second image 37-2, and the third image 37-3 to be displayed at the display section 18. Consequently, the peripheral target object notification image 37 is continuously enlarged from a vehicle image 30E side toward a parked vehicle image 33E side.

When the vehicle speed of the vehicle 10 has become 0 km/h, or the clearance sonars 20 no longer detect that the distance between the vehicle 10 and the peripheral target object is equal to or less than the second predetermined distance, it is determined that the third switching condition is not satisfied, and the parking notification control is switched to the non-actuated state. Consequently, the display control section 222 switches the display section 18 to the normal mode.

In the above-described configuration, the display section 18 and the ECU 21 are constituent elements of a vehicle display control device 40.

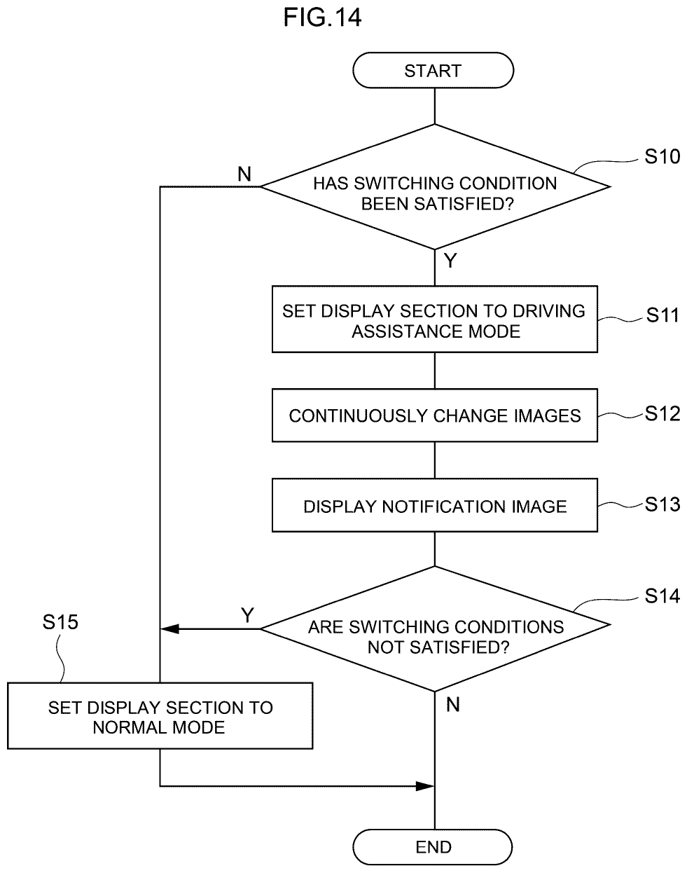

Next, processing executed by the CPU 22 of the ECU 21 will be explained. The CPU 22 repeatedly executes the processing of the flowchart illustrated in FIG. 14 every time a predetermined time has elapsed.

At step S10 (hereinafter, the term “step” is omitted), the CPU 22 determines whether or not a switching condition has been satisfied.

When a determination of Yes has been made at S10, the CPU 22 proceeds to S11 and sets the display section 18 to the driving assistance mode.

When the processing of S11 has been completed, the CPU 22 proceeds to S12 and continuously changes the images displayed at the display section 18. For example, in a case in which the BSM control is in the actuated state, the display section 18 is continuously changed from the state in FIG. 5 to the state in FIG. 7.

When the processing of S12 has been completed, the CPU 22 proceeds to S13 and causes a notification image to be displayed at the display section 18. For example, in a case in which the BSM control is in the actuated state, the approaching vehicle notification image 35 illustrated in FIG. 7 is displayed at the display section 18.

When the processing of S13 has been completed, the CPU 22 proceeds to S14 and determines whether or not the switching conditions are not satisfied.

When a determination of No has been made at S10, or when a determination of Yes has been made at S14, the CPU 22 proceeds to S15 and sets the display section 18 to the normal mode.

When a determination of No has been made at S14, or when the processing of S15 has been completed, the CPU 22 temporarily ends the processing of the flowchart in FIG. 14.

As explained above, when the driving assistance control section 221 determines that a switching condition related to driving assistance control that can be executed by the vehicle 10 has been satisfied, the vehicle display control device 40 of the present exemplary embodiment causes the vehicle images 30A, 30B, 30C, 30D, and 30E, the road images 31A, 31B, 31C, 31D, and 31E, the approaching vehicle images 32B and 32C, and the parked vehicle images 33D and 33E to be displayed at the display section 18, while continuously changing display modes of these images. Accordingly, the vehicle display control device 40 enables an occupant viewing the display section 18 to more easily recognize that the driving assistance control has been switched from the non-actuated state to the actuated state, compared with a case in which the display modes of these images are not changed.

Further, when it is determined that the first switching condition related to the BSM control has been satisfied, the vehicle images 30A, 30B, and 30C displayed at the display section 18 gradually and continuously become smaller accompanying the passage of time. Consequently, the occupant viewing the display section 18 can easily recognize that the BSM control has been switched from the non-actuated state to the actuated state.

Furthermore, the sizes of the vehicle images 30A, 30B, and 30C on the display section 18 gradually become smaller, and the display positions of the vehicle images 30A, 30B, and 30C on the display section 18 gradually move frontward. Consequently, a lower display region between rear ends of the vehicle images 30A, 30B, and 30C and a lower edge portion 18BL (refer to FIGS. 5 to 7) of the display section 18 is gradually enlarged. Thus, when the vehicle images 30B and 30C are displayed at the display section 18, images (the approaching vehicle images 32B and 32C, and the approaching vehicle notification image 35) that are positioned further rearward than the vehicle images 30B and 30C are caused to be displayed in the lower display region. Consequently, the vehicle images 30A and 30B can be displayed so as to be larger on the display section 18 than in a case in which a portion of the display section 18 (the lower display region) is always secured as a region for displaying the approaching vehicle images 32B and 32C, and the approaching vehicle notification image 35.

Further, when it is determined that a switching condition related to the non-actuated state of the SEA control or the parking notification control has been satisfied, the vehicle images 30A, 30D, and 30E displayed at the display section 18 are changed from images when the virtual viewpoint is positioned at PA (a first viewpoint), which is further rearward than the vehicle 10, to images when the virtual viewpoint is positioned at PE (a second viewpoint), which is further frontward and upward than PA. Consequently, the shapes of the vehicle images 30A, 30D, and 30E displayed on the display section 18 are changed accompanying the passage of time. That is to say, the vehicle image 30A representing a shape of the vehicle 10 when the vehicle 10 is viewed from behind and above is changed to the vehicle image 30E representing the vehicle 10 when the vehicle 10 is viewed from directly above. Consequently, an occupant viewing the display section 18 can easily recognize that the SEA control or the parking notification control has been switched from the non-actuated state to the actuated state.

Furthermore, when it is determined that a switching condition related to the SEA control or the parking notification control has been satisfied, the display positions of the vehicle images 30A, 30D, and 30E on the display section 18 gradually move frontward. Consequently, the lower display region between the rear ends of the vehicle images 30A, 30D, and 30E and the lower edge portion 18BL (see FIGS. 8 to 13) of the display section 18 is gradually enlarged. Thus, when the vehicle images 30D and 30E are displayed at the display section 18, images (the parked vehicle images 33D and 33E, the approaching target object notification image 36, and the peripheral target object notification image 37) positioned further rearward than the vehicle images 30D and 30E are caused to be displayed in the lower display region. Consequently, the vehicle images 30A and 30D can be displayed so as to be larger on the display section 18 than in a case in which a portion (the lower display region) of the display section 18 is always secured as a region for displaying the parked vehicle images 33D and 33E, the approaching target object notification image 36, and the peripheral target object notification image 37.

Further, when it is determined that a switching condition has been satisfied, the vehicle display control device 40 causes a notification image (the approaching vehicle notification image 35, the approaching target object notification image 36, and the peripheral target object notification image 37) indicating that the driving assistance control is in the actuated state to be displayed at the display section 18. Accordingly, the vehicle display control device 40 can cause an occupant viewing the display section 18 to easily recognize that the driving assistance control is in the actuated state.

Moreover, when it is determined that a switching condition has been satisfied, the vehicle display control device 40 causes the vehicle images 30A, 30B, 30C, 30D, and 30E, the road images 31A, 31B, 31C, 31D, and 31E, the approaching vehicle images 32B and 32C, and the parked vehicle images 33D and 33E to be displayed at a central portion (a predetermined position) of the display section 18. In other words, these images are not displayed at the display section 18 when the driving assistance control is in the non-actuated state. Accordingly, compared to a case in which these images are displayed at the central portion of the display section 18 when the driving assistance control is in the non-actuated state, it is less likely that an occupant viewing the display section 18 will be made to feel irritation.

Although explanation has been given above regarding a vehicle display control device according to an exemplary embodiment, appropriate design modification thereof can be carried out within a range that does not depart from the spirit of the present disclosure.

For example, when it is determined that a switching condition has been satisfied, the display modes of the vehicle images 30A, 30B, 30C, 30D, and 30E, the road images 31A, 31B, 31C, 31D, and 31E, the approaching vehicle images 32B and 32C, and the parked vehicle images 33D and 33E on the display section 18 may be intermittently changed. For example, when it is determined that the first switching condition related to the BSM control has been satisfied, the vehicle image 30A may be directly changed to the vehicle image 30B without passing through another vehicle image, and the vehicle image 30B may be directly changed to the vehicle image 30C without passing through another vehicle image. Alternatively, the vehicle image 30A may be directly changed to the vehicle image 30C without passing through another vehicle image.

In a case in which the display section 18 is set to the normal mode, the display section 18 may simultaneously display a vehicle image representing the vehicle 10, a road image representing a road on which the vehicle 10 is travelling, and another image that is different from the vehicle image and the road image. This other image may include, for example, a map image and an image representing the vehicle speed of the vehicle 10. Further, in a case in which the display section 18 is set to the normal mode, this other image may be displayed at the central portion (a predetermined position) of the display section 18, and the vehicle image and the road image may be displayed at a side portion of the display section 18. Furthermore, in a case in which the display section 18 is set to the driving assistance mode, a driving assistance-related image may be displayed at the central portion of the display section 18, and the other image may be displayed at the side portion of the display section 18.

When it is determined that a switching condition related to the SEA control or the parking notification control has been satisfied, a size of the field of view angle may be changed while changing a position of the virtual viewpoint, accompanying the passage of time.

Image data representing vehicle images, road images, approaching vehicle images, and parked vehicle images, which have been created not based on 3D modeling data, may be recorded in the ROM 23. In such a case, image data representing vehicle images, road images, approaching vehicle images, and parked vehicle images when viewed from numerous virtual viewpoints that are positioned between the virtual viewpoint PA and the virtual viewpoint PE on the curve CL and that are different from the virtual viewpoint PD may be stored in the ROM 23.

The vehicle images 30A, 30B, 30C, 30D, and 30E, the road images 31A, 31B, 31C, 31D, and 31E, the approaching vehicle images 32B and 32C, and the parked vehicle images 33D and 33E that are displayed at the display section 18 may also be images generated based on image data acquired by plural cameras installed at the vehicle 10.

What is claimed is:

1. A vehicle display control device comprising:
a processor; and
a display section that is provided at a vehicle capable of executing driving assistance control, and that is configured to display a vehicle image representing the vehicle,
the processor being configured to:
determine whether or not a switching condition for switching the driving assistance control from a non-actuated state to an actuated state has been satisfied, and
when it has been determined that the switching condition has been satisfied, control the display section so as to display the vehicle image while changing a display mode of the vehicle image.

2. The vehicle display control device according to claim 1, wherein, when the switching condition has been satisfied, the processor is configured to control the display section so as to display a notification image indicating that the driving assistance control is in the actuated state.

3. The vehicle display control device according to claim 1, wherein, when the switching condition has been satisfied, the processor is configured to control the display section such that the vehicle image gradually becomes smaller accompanying passage of time.

4. The vehicle display control device according to claim 1, wherein:
the vehicle image is an image representing the vehicle when the vehicle is viewed from a predetermined virtual viewpoint, and
when the switching condition has been satisfied, the processor is configured to control the display section such that, accompanying passage of time, the vehicle image is changed from an image when the virtual viewpoint is positioned at a first viewpoint that is further rearward than the vehicle, to an image when the virtual viewpoint is positioned at a second viewpoint that is further frontward and upward than the first viewpoint.

5. The vehicle display control device according to claim 1, wherein the processor is configured to control the display section such that the display mode of the vehicle image is changed continuously.

6. The vehicle display control device according to claim 1, wherein, when it has been determined that the switching condition has been satisfied, the processor is configured to control the display section so as to display the vehicle image at a predetermined position on the display section.
